(19) United States
(12) Patent Application Publication
(10) Pub. No.: US 2026/0129689 A1
(43) Pub. Date: May 7, 2026

(54) EARLY BEAM REFINEMENT FOR A TWO-STEP RANDOM ACCESS CHANNEL (RACH) PROCEDURE

(71) Applicant: QUALCOMM Incorporated, San Diego, CA (US)

(72) Inventors: In-Soo KIM, San Diego, CA (US); Yan ZHOU, San Diego, CA (US); Jing SUN, San Diego, CA (US); Jing JIANG, San Diego, CA (US)

(21) Appl. No.: 18/940,648

(22) Filed: Nov. 7, 2024

(51) Int. Cl. H04W 74/0836; H04B 7/06

(52) U.S. Cl. CPC H04W 74/0836; H04B 7/0695

(57) ABSTRACT

Aspects of the present disclosure relate to wireless communications, and more particularly, to techniques for beam refinement. One aspect provides a method for wireless communications at a user equipment (UE). The method includes: receiving, from a base station (BS), a set of synchronization signal blocks (SSBs) associated with a set of beams, respectively; transmitting, to the BS, a first message of a random access channel (RACH) process using one beam of the set of beams; receiving, from the BS, a second message of the RACH process, wherein the second message triggers a beam refinement process; and receiving a set of reference signals as part of the beam refinement process to identify one or more candidate refined beams.

### FIELD OF THE DISCLOSURE

Aspects of the present disclosure relate to wireless communications, and more particularly, to techniques for beam refinement.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications at a user equipment (UE). The method includes: receiving, from a base station (BS), a set of synchronization signal blocks (SSBs) associated with a set of beams, respectively; transmitting, to the BS, a first message of a random access channel (RACH) process using one beam of the set of beams; receiving, from the BS, a second message of the RACH process, wherein the second message triggers a beam refinement process; and receiving a set of reference signals as part of the beam refinement process to identify one or more candidate refined beams.

Another aspect provides a method for wireless communications at a base station (BS). The method includes: transmitting, to a user equipment (UE), a set of synchronization signal blocks (SSBs) associated with a set of beams, respectively; receiving, from the UE, a first message of a random access channel (RACH) process using one beam of the set of beams; transmitting, to the UE, a second message of the RACH process, wherein the second message triggers a beam refinement process; and transmitting a set of reference signals as part of the beam refinement process to identify one or more candidate refined beams.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station (BS) architecture.

FIG. 3 depicts aspects of an example base station and an example user equipment (UE).

FIGS. 4A, 4B, 4C, and 4D depict various example aspects of data structures for a wireless communications network.

FIG. 5A is a call flow diagram illustrating an example of a four-step random access procedure (RACH) procedure.

FIG. 5B is a call flow diagram illustrating an example two-step RACH procedure.

FIG. 6 is a diagram illustrating example beam management procedures in accordance with the present disclosure.

FIG. 7 illustrates example signal communications for beam refinement after a four-step RACH procedure.

FIG. 8 illustrates example signal communications for beam refinement with RACH message repetition.

FIG. 9 illustrates example signal communications with a RACH message triggering UE and BS beam refinement, in accordance with certain aspects of the present disclosure.

FIG. 10 illustrates example signal communications with a RACH message triggering BS beam refinement, in accordance with certain aspects of the present disclosure.

FIG. 11 illustrates example signal communications with a RACH message triggering UE beam refinement, in accordance with certain aspects of the present disclosure.

FIG. 12 illustrates example signal communications including transmission of UE capability, in accordance with certain aspects of the present disclosure.

FIG. 13 illustrates example signal communications with an acknowledgment (ACK) transmitted along with a beam report, in accordance with certain aspects of the present disclosure.

FIG. 14 illustrates example signal communications including a separate message for ACK, in accordance with certain aspects of the present disclosure.

FIG. 15 illustrates example signal communications with UE beam refinement and ACK, in accordance with certain aspects of the present disclosure.

FIG. 16 illustrates example signal communications with a fallback random access request (RAR) used to trigger BS and/or UE beam refinement, in accordance with certain aspects of the present disclosure.

FIG. 17 illustrates example signal communications with a fallback RAR used to trigger BS beam refinement, in accordance with certain aspects of the present disclosure.

FIG. 18 illustrates example signal communications with a fallback RAR used to trigger UE beam refinement, in accordance with certain aspects of the present disclosure.

FIG. 19 depicts a method for wireless communications.

FIG. 20 depicts a method for wireless communications.

FIG. 21 depicts aspects of an example communications device.

FIG. 22 depicts aspects of an example communications device.

### DETAILED DESCRIPTION

Aspects of the present disclosure provide apparatuses, methods, processing systems, and computer-readable mediums for early beam refinement. Typically, beam refinement operations may be delayed once a user equipment (UE) has connected to the network. For example, beam refinement may occur after random access channel (RACH) operations have been performed. While beam refinement may be performed during RACH operations using message repetition, such beam refinement may be available only for base station (BS) beam refinement. Certain aspects of the present disclosure are directed towards techniques for performing early beam refinement as part of a two-step RACH process with a message of the RACH process triggering reference signal (RS) transmissions for beam refinement. The beam refinement may include UE beam refinement operations, BS beam refinement operations, or BS and UE beam refinement operations. In some cases, a first message of the RACH process may be used to communicate UE capabilities, where a second message of the RACH process triggers the beam refinement in accordance the UE capabilities, as described in more detail herein.

Some aspects provide techniques for acknowledging the message triggering the beam refinement. In some cases, the acknowledgement may be performed after the RS transmissions have occurred for the beam refinement so that the same message can be used for both the acknowledgement and a beam report for the beam refinement process, reducing signaling overhead. In some cases, the acknowledgement may be performed before the RS transmissions so that the RS transmissions can be avoided if the message triggering the beam refinement was not successfully received by the UE, preventing wasted energy at the BS transmitting RSs that the UE is unaware of.

Some aspects provide techniques for performing beam refinement in case the two-step RACH process fails. For example, a random access response (RAR) fallback message that is used to transition from the two-step RACH process to a four-step RACH process may also be used to trigger the beam refinement. In this case, a third message of the four-step RACH process may be used by the UE to provide a beam report, and a fourth message of the four-step RACH process may be used by the BS to indicate a beam to be used for communications.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

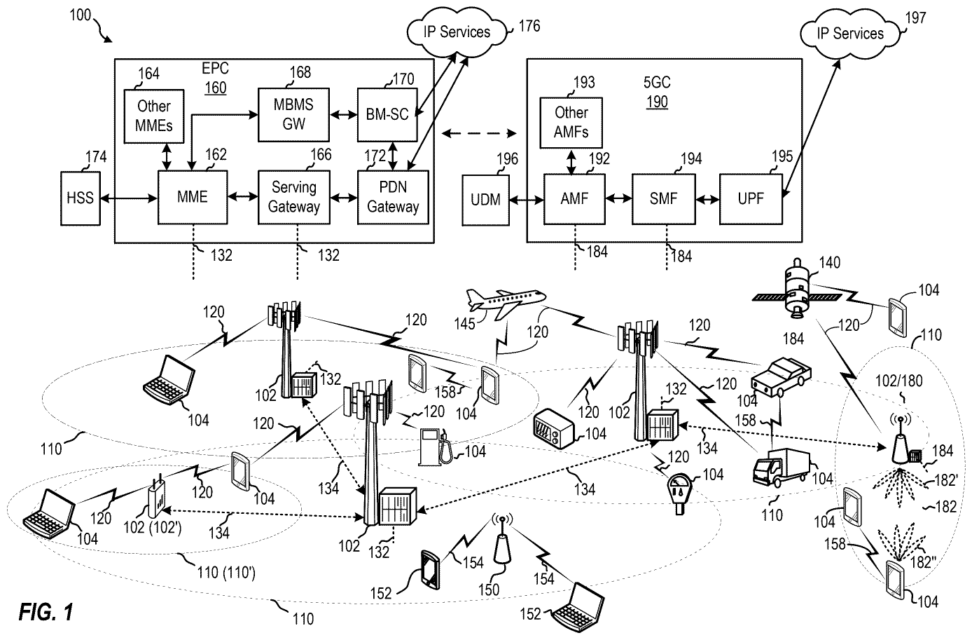

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

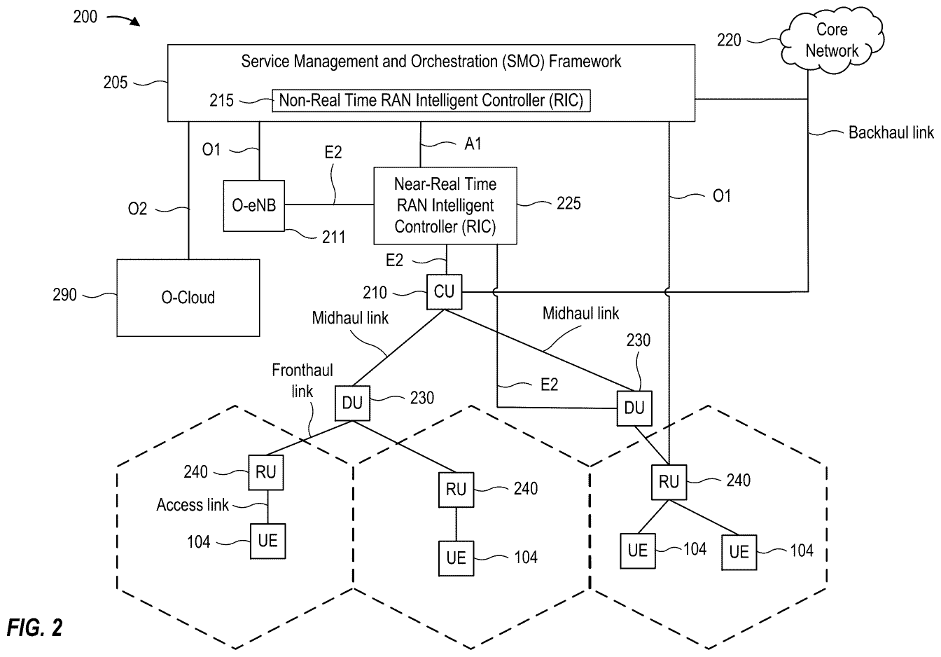

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5 GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1(FR 1 ) as including 410 MHz- 7125 MHz, which is often referred to (interchangeably) as “Sub-6 GHz”. Similarly, 3GPP currently defines Frequency Range 2(FR 2 ) as including 24,250 MHz - 71,000 MHz, which is sometimes referred to (interchangeably) as a “millimeter wave” (“mmW” or “mmWave”). In some cases, FR2 may be further defined in terms of sub-ranges, such as a first sub-range FR 2-1 including 24,250 MHz - 52,600 MHz and a second sub-range FR 2 -2 including 52,600 MHz - 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5 GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit—User Plane (CU-UP)), control plane functionality (e.g., Central Unit—Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

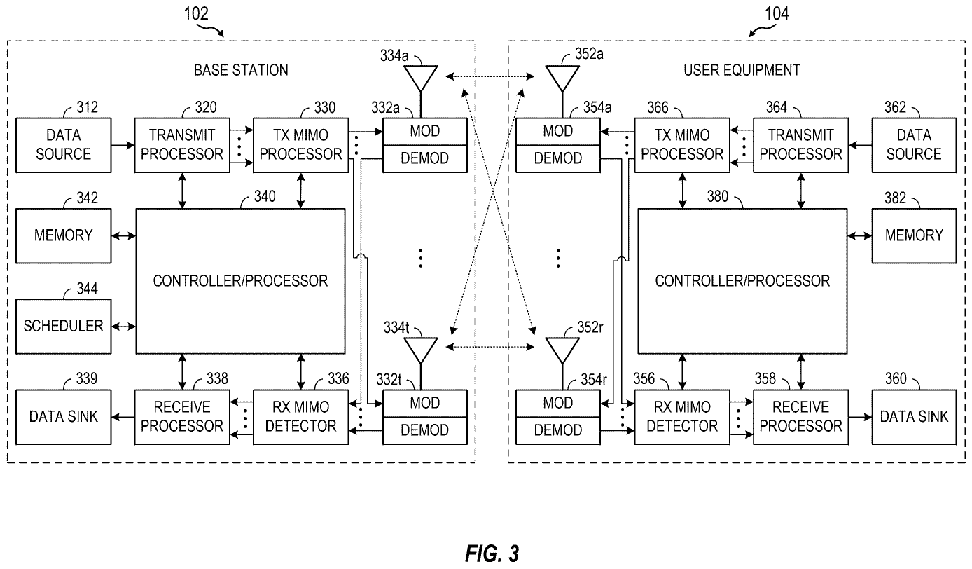

FIG. 3 depicts aspects of an example BS 102 and a UE 104.

Generally, BS 102 includes various processors (e.g., 320, 330, 338, and 340), antennas 334 a-t (collectively 334), transceivers 332 a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352 a-r (collectively 352), transceivers 354 a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332 a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354 a-t, RX MIMO detector 356, controller/processor 380, receive processor 358, memory 382, and/or other aspects described herein.

In some aspects, one or more processors may be configured to perform various operations, such as those associated with the methods described herein, and transmit (output) to or receive (obtain) data from another interface that is configured to transmit or receive, respectively, the data.

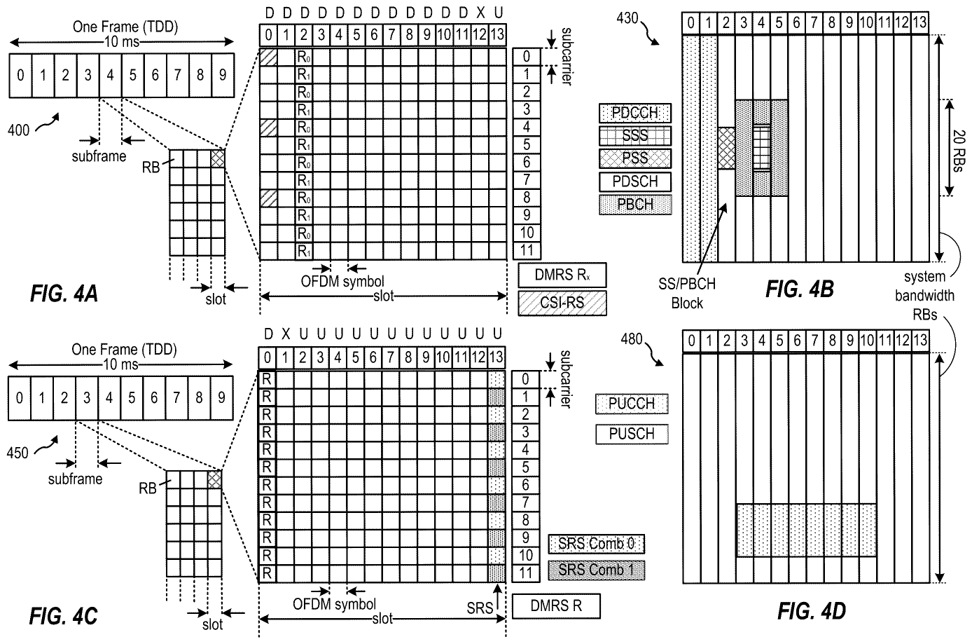

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2 μ slots/subframe. The subcarrier spacing and symbol length/duration are a function of the numerology. The subcarrier spacing may be equal to 2^{μ}×15 kHz, where μ is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Four-step Random Access Procedure

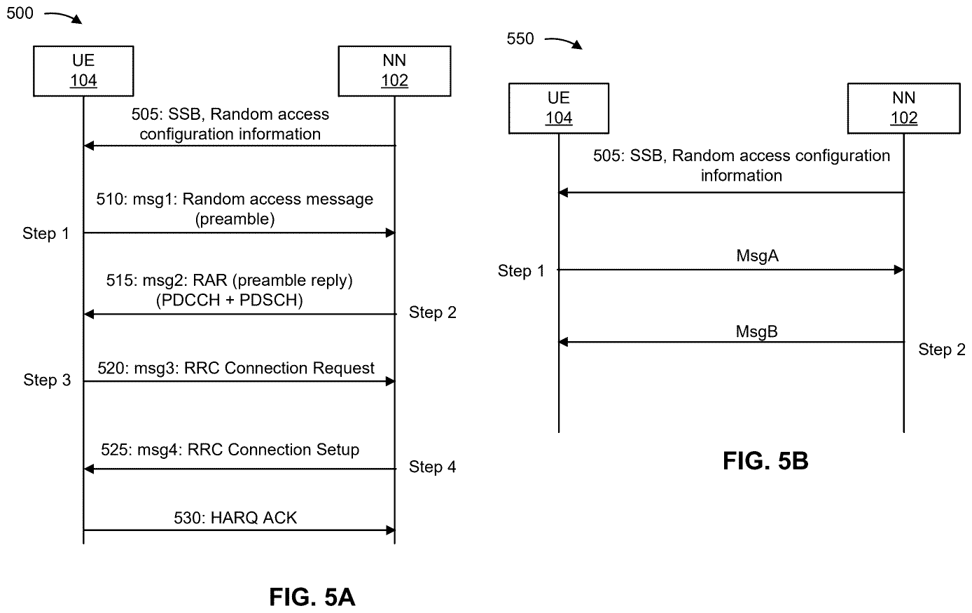

FIG. 5A is a diagram illustrating an example of a four-step random access procedure in accordance with the present disclosure. As shown in FIG. 5A, a BS 102 (e.g., network node (NN)) and a UE 104 may communicate with one another to perform the four-step random access procedure.

In a first operation 505, the BS 102 may transmit, and the UE 104 may receive, one or more synchronization signal blocks (SSBs) and random access configuration information. In some examples, the random access configuration information may be transmitted in and/or indicated by system information (for example, in one or more SIBs) and/or an SSB, such as for contention-based random access. Additionally or alternatively, the random access configuration information may be transmitted in a radio resource control (RRC) message and/or a physical downlink control channel (PDCCH) order message that triggers a RACH procedure (also referred to as a “RACH process” or “RACH operations”), such as for contention-free random access. The random access configuration information may include one or more parameters to be used in the random access procedure, such as one or more parameters for transmitting a random access message (RAM) and/or one or more parameters for receiving a random access response (RAR).

In a second operation 510, the UE 104 may transmit a RAM, which may include a preamble (sometimes referred to as a random access preamble, a PRACH preamble, or a RAM preamble). The message that includes the preamble may be referred to as a message 1, Msg1, MSG1, a first message, or an initial message in a four-step random access procedure. The random access message may include a random access preamble identifier.

In a third operation 515, the BS 102 may transmit an RAR as a reply to the preamble. The message that includes the RAR may be referred to as message 2, Msg2, MSG2, or a second message in a four-step random access procedure. In some examples, the RAR may indicate the detected random access preamble identifier (for example, received from the UE 104 in Msg1). Additionally or alternatively, the RAR may indicate a resource allocation to be used by the UE 104 to transmit message 3 (Msg3).

In some examples, as part of the second step of the four-step random access procedure, the BS 102 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the BS 102 may transmit the PDSCH communication for the RAR, as scheduled by the PDCCH communication. The RAR may be included in a MAC protocol data unit (PDU) of the PDSCH communication.

In a fourth operation 520, the UE 104 may transmit an RRC connection request message. The RRC connection request message may be referred to as message 3, Msg3, MSG3, or a third message of a four-step random access procedure. In some examples, the RRC connection request may include a UE identifier, UCI, and/or a PUSCH communication (for example, an RRC connection request).

In a fifth operation 525, the BS 102 may transmit an RRC connection setup message. The RRC connection setup message may be referred to as message 4, Msg4, MSG4, or a fourth message of a four-step random access procedure. In some examples, the RRC connection setup message may include the detected UE identifier, a timing advance value, and/or contention resolution information. In a sixth operation 530, if the UE 104 successfully receives the RRC connection setup message, the UE 104 may transmit a HARQ ACK.

FIG. 5B is a call flow diagram 550 illustrating an example two-step RACH procedure, in accordance with certain aspects of the present disclosure. A first enhanced message (MsgA) may be sent from the UE 104 to BS 102. In certain aspects, MsgA includes some or all the information from Msg1 and Msg3 from the four-step RACH procedure, effectively combining Msg1 and Msg3. For example, MsgA may include Msg1 and Msg3 multiplexed together such as using one of time-division multiplexing or frequency-division multiplexing. In certain aspects, MsgA includes a RACH preamble for random access and a payload. The MsgA payload, for example, may include the UE-ID and other signaling information (e.g., buffer status report (BSR)) or scheduling request (SR). BS 102 may respond with a random access response (RAR) message (MsgB) which may effectively combine Msg2 and Msg4 described herein. For example, MsgB may include the ID of the RACH preamble, a timing advance (TA), a back off indicator, a contention resolution message, UL/DL grant, and transmit power control (TPC) commands. In a two-step RACH procedure, the MsgA may include a RACH preamble and a payload. In some cases, the RACH preamble and payload may be sent in a MsgA transmission occasion.

The random access message (MsgA) transmission occasion generally includes a MsgA preamble occasion (for transmitting a preamble signal) and a MsgA payload occasion for transmitting a PUSCH. In some cases, a UE monitors SSB transmissions which are sent (by a gNB using different beams) and are associated with a finite set of time/frequency resources defining RACH occasions (ROs) and PUSCH resource units (PRUs). Upon detecting an SSB, the UE may select an RO and one or more PRUs associated with that SSB for a MSG1/msgA transmission. There are several benefits to a two-step RACH procedure, such as speed of access and the ability to send a relatively small amount of data without the overhead of a full four-step RACH procedure to establish a connection (when the four-step RACH messages may be larger than the payload). The two-step RACH procedure can operate in any RRC state and any supported cell size. Networks that uses two-step RACH procedures can typically support contention-based random access (CBRA) transmission of messages (e.g., MsgA) within a finite range of payload sizes and with a finite number of MCS levels. While example RACH procedures such as a four-step RACH procedure and a two-step RACH procedure have been described, certain aspects of the present disclosure may be implemented for any suitable RACH procedure.

### Introduction to Beam Management Procedures

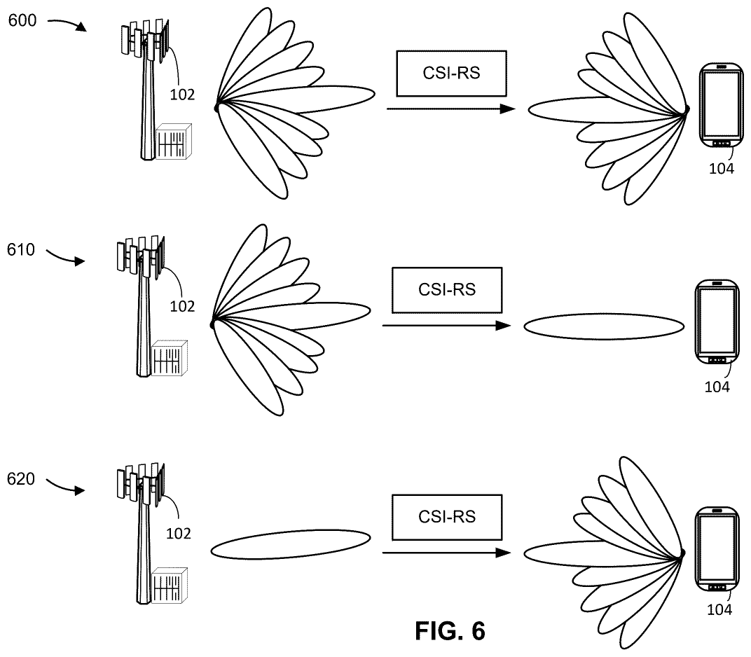

FIG. 6 is a diagram illustrating examples 600, 610, and 620 of CSI-RS beam management procedures in accordance with the present disclosure. As shown in FIG. 6, examples 600, 610, and 620 include a UE 104 in communication with a BS 102 in a wireless network. However, the devices shown in FIG. 6 are provided as examples, and the wireless network may support communication and beam management between other devices (for example, between a UE 104 and a BS 102 or transmit receive point (TRP), between a mobile termination node and a control node, between an integrated access and backhaul (IAB) child node and an IAB parent node, and/or between a scheduled node and a scheduling node). In some examples, the UE 104 and the BS 102 may be in a connected state (for example, an RRC connected state).

As shown in FIG. 6, example 600 may include a BS 102 (for example, one or more network node devices such as an RU, a DU, and/or a CU, among other examples) and a UE 104 communicating to perform beam management using CSI-RSs. Example 600 depicts a first beam management procedure (for example, P1 CSI-RS beam management). The first beam management procedure may be referred to as a beam selection procedure, an initial beam acquisition procedure, a beam sweeping procedure, a cell search procedure, and/or a beam search procedure. As shown in FIG. 6 and example 600, CSI-RSs may be configured to be transmitted from the BS 102 to the UE 104. The CSI-RSs may be configured to be periodic (for example, using RRC signaling), semi-persistent (for example, using MAC-CE signaling), and/or aperiodic (for example, using DCI).

The first beam management procedure may include the BS 102 performing beam sweeping over multiple transmit (Tx) beams. The BS 102 may transmit a CSI-RS using each transmit beam for beam management. To enable the UE 104 to perform receive (Rx) beam sweeping, the network node may use a transmit beam to transmit (for example, with repetitions) each CSI-RS at multiple times within the same reference signal (RS) resource set so that the UE 104 can sweep through receive beams in multiple transmission instances. For example, if the BS 102 has a set of N transmit beams and the UE 104 has a set of M receive beams, the CSI-RS may be transmitted on each of the N transmit beams M times so that the UE 104 may receive M instances of the CSI-RS per transmit beam. In other words, for each transmit beam of the BS 102, the UE 104 may perform beam sweeping through the receive beams of the UE 104. As a result, the first beam management procedure may enable the UE 104 to measure a CSI-RS on different transmit beams using different receive beams to support selection of BS transmit beams/UE receive beam(s) beam pair(s). The UE 104 may report the measurements to the BS 102 to enable the BS 102 to select one or more beam pair(s) for communication between the BS 102 and the UE 104. While example 600 has been described in connection with CSI-RSs, the first beam management process may also use SSBs for beam management in a similar manner as described above.

As shown in FIG. 6, example 610 may include a BS 102 and a UE 104 communicating to perform beam management using CSI-RSs. Example 610 depicts a second beam management procedure (for example, P2 CSI-RS beam management). The second beam management procedure may be referred to as a beam refinement procedure, a network node beam refinement procedure, a TRP beam refinement procedure, and/or a transmit beam refinement procedure. As shown in FIG. 6 and example 610, CSI-RSs may be configured to be transmitted from the BS 102 to the UE 104. The CSI-RSs may be configured to be aperiodic (for example, using DCI). The second beam management procedure may include the BS 102 performing beam sweeping over one or more transmit beams. The one or more transmit beams may be a subset of all transmit beams associated with the BS 102 (for example, determined based at least in part on measurements reported by the UE 104 in connection with the first beam management procedure). The BS 102 may transmit a CSI-RS using each transmit beam of the one or more transmit beams for beam management. The UE 104 may measure each CSI-RS using a single (for example, a same) receive beam (for example, determined based at least in part on measurements performed in connection with the first beam management procedure). The second beam management procedure may enable the BS 102 to select a best transmit beam based at least in part on measurements of the CSI-RSs (for example, measured by the UE 104 using the single receive beam) reported by the UE 104.

As shown in FIG. 6, example 620 depicts a third beam management procedure (for example, P3 CSI-RS beam management). The third beam management procedure may be referred to as a beam refinement procedure, a UE beam refinement procedure, and/or a receive beam refinement procedure. As shown in FIG. 6 and example 620, one or more CSI-RSs may be configured to be transmitted from the BS 102 to the UE 104. The CSI-RSs may be configured to be aperiodic (for example, using DCI). The third beam management process may include the BS 102 transmitting the one or more CSI-RSs using a single transmit beam (for example, determined based at least in part on measurements reported by the UE 104 in connection with the first beam management procedure and/or the second beam management procedure). To enable the UE 104 to perform receive beam sweeping, the network node may use a transmit beam to transmit (for example, with repetitions) CSI-RS at multiple times within the same RS resource set so that UE 104 can sweep through one or more receive beams in multiple transmission instances. The one or more receive beams may be a subset of all receive beams associated with the UE 104 (for example, determined based at least in part on measurements performed in connection with the first beam management procedure and/or the second beam management procedure). The third beam management procedure may enable the BS 102 and/or the UE 104 to select a best receive beam based at least in part on reported measurements received from the UE 104 (for example, of the CSI-RS of the transmit beam using the one or more receive beams).

Other examples of beam management procedures may differ from what is described with respect to FIG. 6. For example, the UE 104 and the BS 102 may perform the third beam management procedure before performing the second beam management procedure, and/or the UE 104 and the BS 102 may perform a similar beam management procedure to select a UE transmit beam. While example beam refinement techniques are described to facilitate understanding, certain aspects of the present disclosure may be applied with any sutiable beam refinement process.

### Aspects Related to Early Beam Refinement

Certain aspects of the present disclosure are directed towards techniques for performing aperiodic P2 and/or P3 beam refinement. As used herein, P2 beam refinement generally refers to operations for BS beam refinement (e.g., refining one or more beams used by the BS) and P3 beam refinement generally refers to operations for UE beam refinement (e.g., refining one or more beams used by the UE). P2/P3 beam refinement generally refers to operations for performing both BS and UE beam refinement. Certain aspects facilitate beam refinement to be triggered early during a random access channel (RACH) procedure such as a two-step RACH procedure.

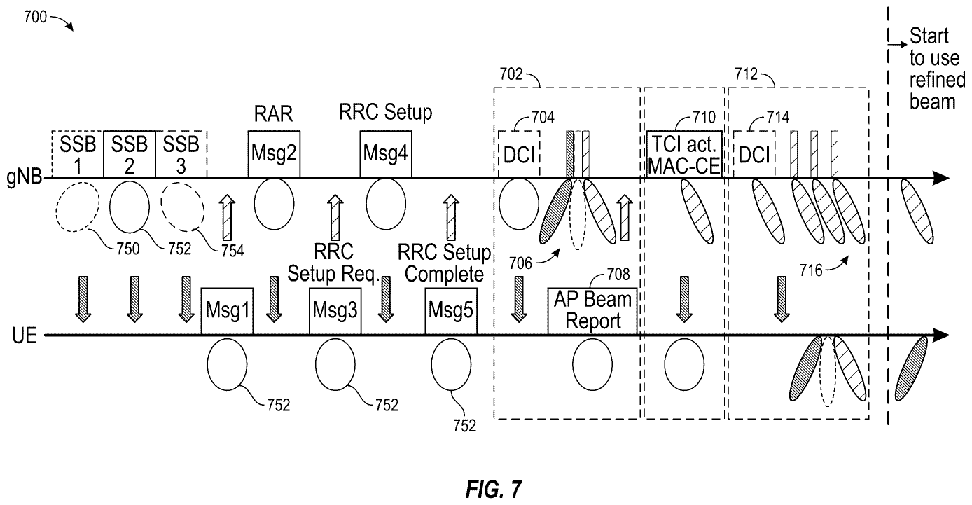

FIG. 7 illustrates example signal communications 700 for beam refinement after a four-step RACH procedure is performed. As shown, a BS may transmit synchronization signal blocks (SSBs) such as the SSBs labeled “SSB1”, “SSB2”, and “SSB3.” The SSBs may be transmitted using different wide beams 750, 752, 754. A UE may receive the SSBs, select one of the SSBs (e.g., such as SSB2 with the highest signal quality), and transmit a first RACH message (Msg1) using the beam 752 associated with the selected SSB. The BS may respond with a second RACH message (Msg2) which may be referred to as a random access response (RAR), as described herein. The UE may then transmit a third RACH message (Msg3) including a radio resource control (RRC) setup request. The BS may then respond with a fourth RACH message (Msg4) for RRC setup, which may be followed by the UE transmitting a fifth message (Msg5) indicating that RRC setup is complete.

In some implementations, for idle UE initial access in multi-beam operations, a BS (e.g., gNB) may trigger aperiodic P2/P3 beam refinement. and transmission configuration indication (TCI) after radio resource control (RRC) setup complete in Msg5. After RRC setup complete, the BS may trigger an aperiodic P2 beam report for the BS beam refinement 702, as shown. For example, the BS beam refinement 702 may include the BS transmitting downlink control information (DCI) 704 indicating beam sweep operations, followed by the BS transmitting a set of narrow beams 706. The UE may then select one or more of the narrow beams with the highest signal quality and report the one or more narrow beams to the BS as part of an aperiodic (AP) beam report 708. Based on the aperiodic beam report, the BS may transmit a TCI activation media access control (MAC) control element (CE) 710 to activate/indicate the TCI for the desired BS narrow beam. For the indicated TCI, aperiodic P3 beam refinement 712 may be further triggered to refine the corresponding UE beam. The refinement 712 may include the BS transmitting DCI 714 followed by transmitting a set of signals using the selected BS narrow beam, which may be received by the UE using a set of different Rx beams allowing the UE to select one of the Rx beams with the highest signal quality for communications. The refined BS/UE beam can be applied to following message exchanges.

In some cases, the aperiodic P2/P3 beam refinement may be slow. For example, as described, the aperiodic P2/P3 beam refinement may start only after RRC setup is complete. Moreover, the aperiodic P2/P3 beam refinement may take about 30 slots for subcarrier spacing (SCS) of 120 kHz and 5 slots for SCS of 15 kHz. In other words, the aperiodic P2 and/or P3 beam refinement, which may include the network beam refinement, the TCI activation, and the UE beam refinement, may have excessive delays. For an SCS of 15 kHz, the network beam refinement may be 1 slot, the TCI activation may be 3 slots, and the UE beam refinement may be 1 slot, resulting in a total of 5 slots for the aperiodic P2 and/or P3 beam refinement. For an SCS of 120 kHz, the network beam refinement may be 3 slots, the TCI activation may be 24 slots, and the UE beam refinement may be 3 slots, resulting in a total of 30 slots for the aperiodic P2 and/or P3 beam refinement. In some cases, beam refinement may be performed with Msg1 repetition.

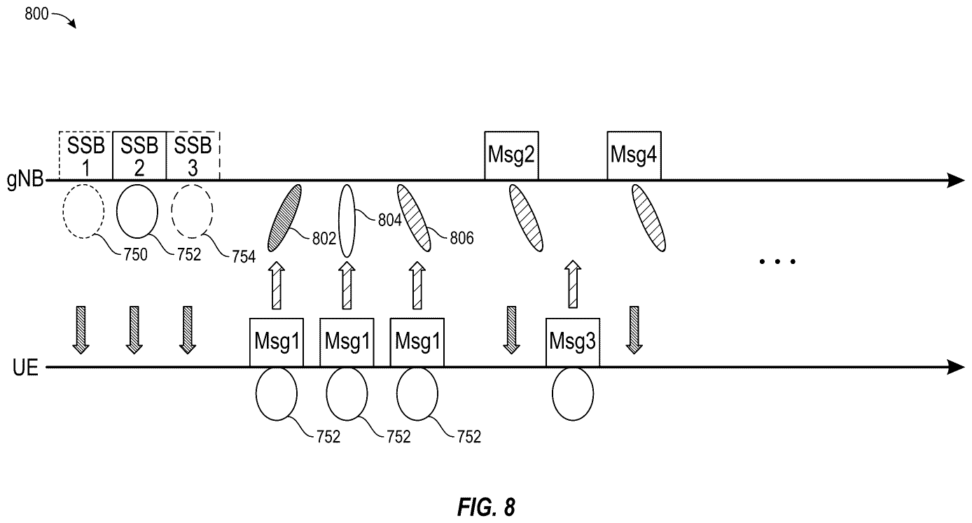

FIG. 8 illustrates example signal communications 800 for beam refinement with Msg1 repetition. In case of Msg1 repetition, the BS by implementation may refine the BS beam via beam sweep within the associated SSB beam (e.g., beam 752). For example, after a wide beam 752 is selected using the SSB transmissions, the UE may transmit repetitions of Msg1 using the selected wide beam. The BS may perform a narrow beam sweep within the selected wide beam 752. The BS may then select one beam 806 of the narrow Rx beams 802, 804, 806 to transmit Msg2 and Msg4. The Msg1 repetition includes sequence repetition within a preamble format, and in some cases, a preamble repetition. The refined BS narrow beam may be applied to later downlink (DL) transmissions and uplink (UL) receptions Rx, reducing the number of repetitions to achieve a certain level of coverage. However, in this case, only the BS beam refinement is supported during initial access.

Certain aspects of the present disclosure provide techniques for early beam refinement during a two-step RACH procedure. One distinctive feature of the two-step RACH procedure (e.g., as opposed to the four-step RACH procedure) is that the first message (MsgA) with a physical uplink shared channel (PUSCH) can carry meaningful information such as the UE capability, allowing for beam refinement to be triggered in accordance with the UE capabilities. Certain aspects provide an early beam refinement scheme for the two-step RACH procedure where MsgB can trigger the BS and/or UE beam refinement.

In some aspects, to expedite the ramp-up from the initial wide beam to the best narrow beam, MsgB of the two-step RACH procedure may trigger the BS and/or UE beam refinement. In certain aspects, to carry out the BS and/or UE beam refinement conforming to the UE capability, MsgA-PUSCH informs the beam refinement UE capability. Certain aspects of the present disclosure indicate when the UE is to transmit an acknowledgment (ACK) of MsgB, as described in more detail herein. In case of the MsgA-PUSCH decoding failure, a fallback RAR can trigger the BS and/or UE beam refinement. A fallback RAR is a message used for a UE to fallback to the four-step RACH procedure after the two-step RACH procedure has failed.

With the techniques described herein, a separate high-latency beam refinement procedure after RRC setup complete, e.g., aperiodic P2/P3 beam refinement and TCI indication, may not be performed, reducing the latency associated with beam refinement once a UE connects to the network. In case MsgB triggers the BS and/or UE beam refinement, the link quality may be improved, at least for the RRC setup request/complete messages.

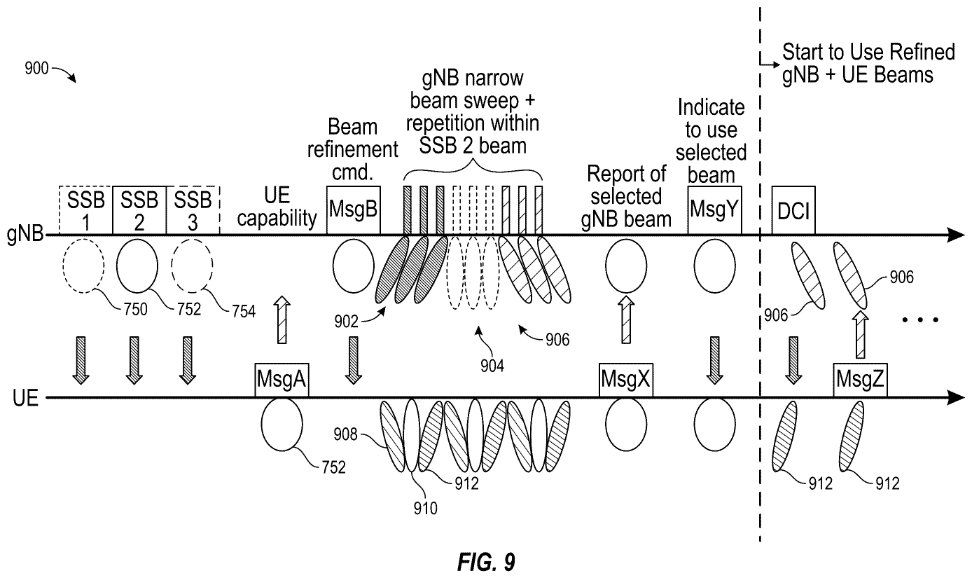

FIG. 9 illustrates example signal communications 900 with MsgB triggering P2/P3 beam refinement, in accordance with certain aspects of the present disclosure. To expedite the ramp-up from the initial wide beam to the best narrow beam, MsgB can trigger the BS and/or UE beam refinement such as P2 beam refinement, P3 beam refinement, or P2/P3 beam refinement. As shown, the UE may transmit MsgA and the BS may respond with MsgB (e.g., including a beam refinement command), triggering the BS and/or UE beam refinement by scheduling CSI-RS transmissions.

The BS and/or UE beam refinement may be carried out based on the scheduled CSI-RS. For example, the BS may transmit CSI-RSs using the Tx beam 902, CSI-RSs using the Tx beam 904, and CSI-RSs using the Tx beam 906. The UE may receive the CSI-RSs using each of the beams 902, 904, 906 with different beams such as beams 908, 910, 912, allowing the UE to identify one or more best beams for the BS and one or more best beams for the UE. For instance, the UE may determine that the best BS beam is beam 906 and the best UE beam is beam 912.

In case of P2 or P2/P3 beam refinement that involves the BS beam refinement, the refined beam pair is used after the UE transmit a beam report (e.g., using a message labeled “Msgx”) indicating the identified one or more best beams (e.g., one or more candidate refined beams) and the BS indication of the best beam pair (e.g., using a message labeled “MsgY”) to be used. For instance, using MsgX transmitted using beam 752, the UE may report one or more beam pairs with the highest signal quality, and the BS may respond, using MsgY transmitted using beam 752, with a selection of one of the beam pairs to be used for transmission. Thus, as shown, a BS may transmit DCI using the selected beam 906 that is received via beam 912. The UE may also use the beam 912 for transmission of a message labeled “MsgZ” that is scheduled via the DCI and the BS may receive MsgZ via the beam 906. In case of P3 beam refinment, neither the beam report nor the BS indication of the best beam pair may be used (e.g., MsgX and MsgY may be skipped) because only UE side beam refinement is performed. The BS and UE may use the initial beam of the best SSB (e.g., beam 752) until the best beam pair (e.g., beams 906, 912) is determined/indicated.

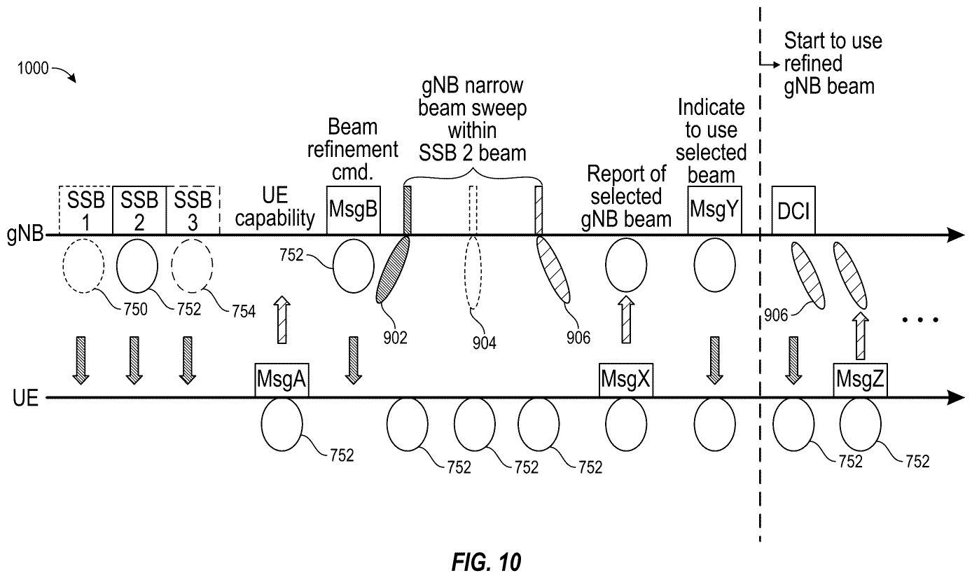

FIG. 10 illustrates example signal communications 1000 with MsgB triggering P2 beam refinement, in accordance with certain aspects of the present disclosure. In this case, after MsgB triggering P2 beam refinement, the BS may transmit a CSI-RS using beam 902, a CSI-RS using beam 904, and a CSI-RS using beam 906, which are received using the wide beam 752. The UE may report back one or more of the beams 902, 904, 906 with the highest quality using MsgX and the BS may indicate a beam to be used using MsgY. The DCI may be transmitted using beam 906 and received using beam 752, and MsgZ may be transmitted using beam 752 and received using beam 906.

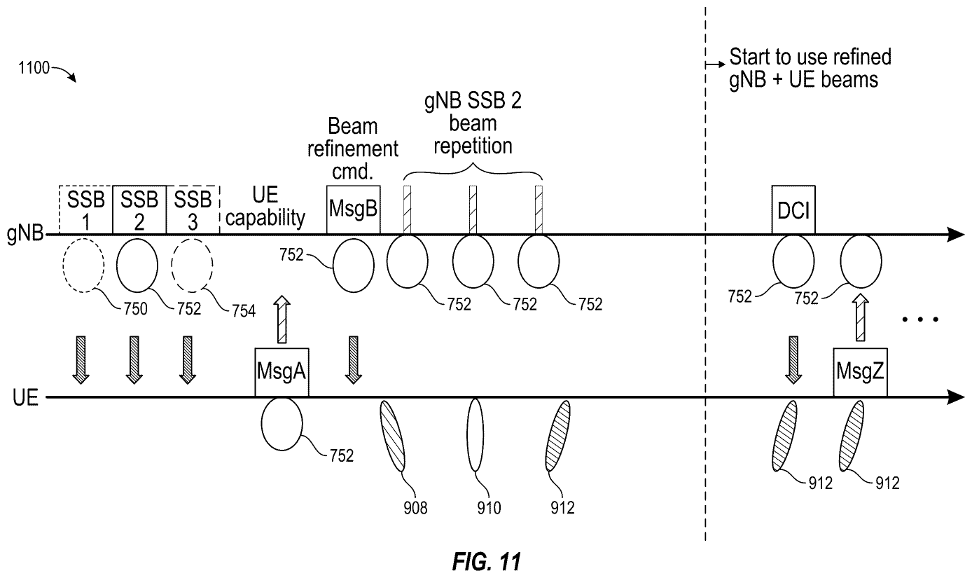

FIG. 11 illustrates example signal communications 1100 with MsgB triggering P3 beam refinement, in accordance with certain aspects of the present disclosure. In this case, after MsgB triggering P3 beam refinement, the BS may transmit CSI-RSs using the beam 752, which are received using the respective beams 908, 910, 912. The UE may select one of the beams 908, 910, 912 with the highest signal quality such as beam 912. The DCI may be transmitted using beam 752 and received using the selected beam 912, and MsgZ may be transmitted using beam 912 and received using beam 752.

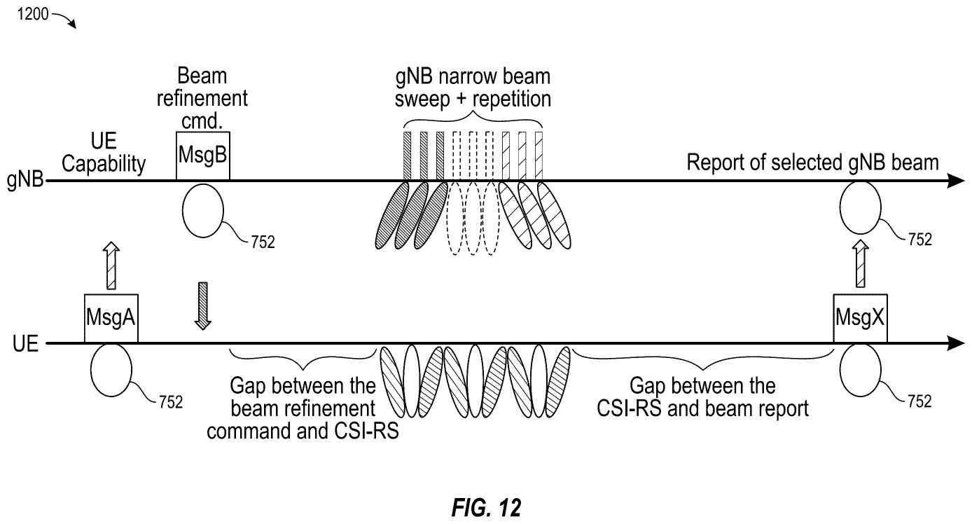

FIG. 12 illustrates example signal communications 1200 including transmission of UE capability, in accordance with certain aspects of the present disclosure. To carry out the BS and/or UE beam refinement conforming to the UE capability, MsgA-PUSCH may be used to inform the beam refinement UE capability, as shown.

In some aspects, the UE capability may includes a UE beam configuration. For example, in case of UE beam refinement, the number of BS beam repetitions may be determined based on the number of UE beams indicated in the UE beam configuration. As an example, referring back to FIG. 11, the number of repetitions may be three to support the three beams 908, 910, 912 of the UE.

In some aspects, the UE capability may include a type of beam refinement the UE is capable of such as whether the UE is capable of P2 beam refinement, P3 beam refinement, or P2/P3 beam refinement. In some aspects, the UE capability may include RS measurement and report configuration. For instance, the UE may indicate that the UE can measure a certain number of RSs and report a certain number of RSs. As an example, referring back to FIG. 9, the UE may be capable of measuring nine beams (e.g., beams 908, 910, 912 for each of beams 902, 904, 906) and capable of reporting the top two beams in MsgX.

In case of P2 or P2/P3 beam refinement that involves the BS beam refinement, the minimum gap between the scheduled CSI-RS and beam report may be indicated, as shown in FIG. 12. For example, the gap may be the amount of time the UE uses to process/transmit the beam report from the CSI-RS measurement. In case of P3 or P2/P3 refinement that involves the UE beam refinement, the UE capability may include the minimum gap between the beam refinement command and the scheduled CSI-RS, as shown. This minimum gap may be the amount of time the UE uses to prepare the beam sweep. As a result, the gap between (1) beam refinement command and scheduled CSI-RS and/or (2) scheduled CSI-RS and beam report may be greater than the associated minimum gap indicated in the beam refinement UE capability.

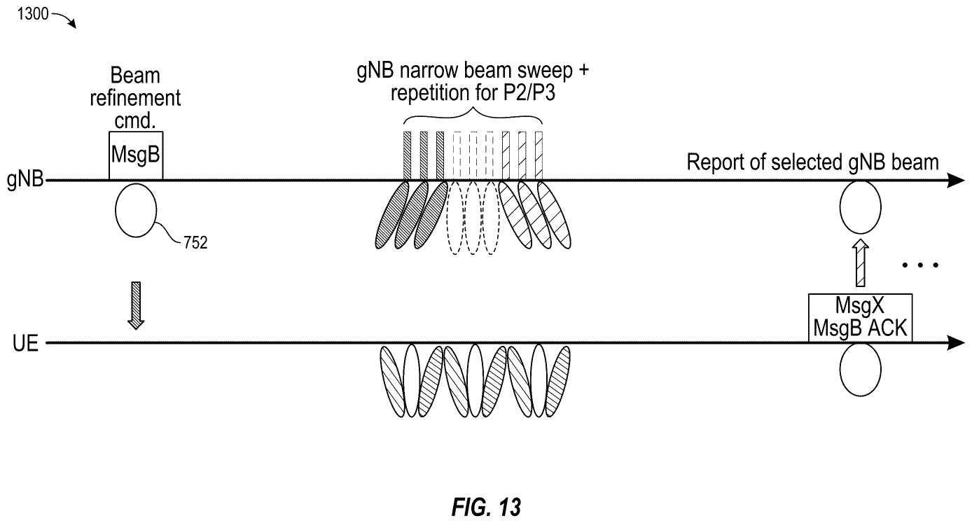

FIG. 13 illustrates example signal communications 1300 with an acknowledgment (ACK) transmitted along with a beam report, in accordance with certain aspects of the present disclosure. In case of P2 or P2/P3 beam refinement that involves the BS beam refinement, the beam refinement is triggered by MsgB followed by the beam report. That is, MsgB may be transmitted, followed by CSI-RS transmissions and transmission of a beam report as part of MsgX. In some aspects, the UE may multiplex an ACK of MsgB (e.g., referred to as “MsgB ACK”) with the beam report as part of MsgX (e.g., providing an explicit MsgB ACK).

In some cases, the beam report may serve as the MsgB ACK, implicitly acknowledging MsgB. In this case, since the MsgB ACK is transmitted after the CSI-RS transmissions, the scheduled CSI-RS may be transmitted regardless of whether MsgB is received/decoded in the MsgB response window or not. In other words, even if MsgB is not properly received/decoded, the BS may not be aware of the decoding failure until after CSI-RS is already transmitted. However, by multiplexing the MsgB ACK with the beam report, an additional message for the ACK may not be used. Thus, signaling overhead may be reduced by merging MsgB ACK with the beam report, although at the cost of the scheduled CSI-RS being transmitted even if MsgB is not received/decoded, resulting in the BS wasting energy on transmitting CSI-RS that the UE is unaware of.

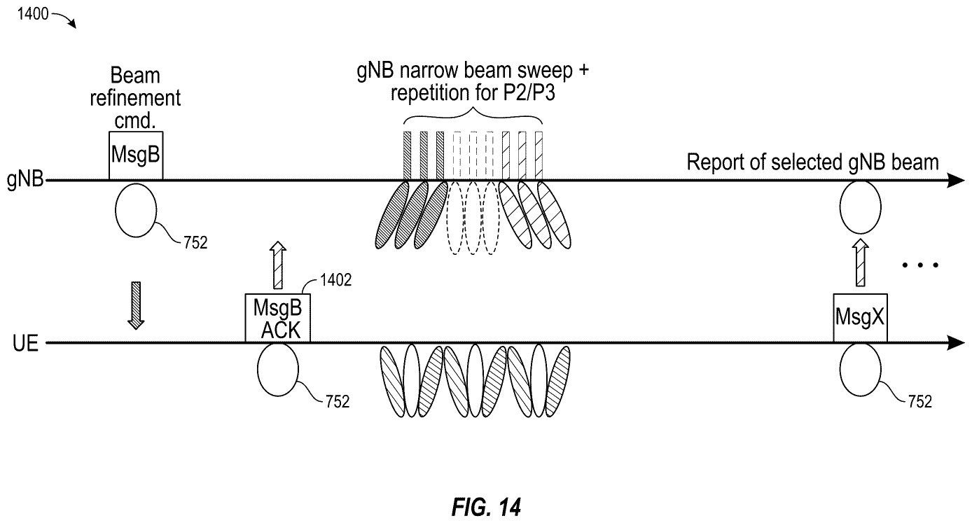

FIG. 14 illustrates example signal communications 1400 including a separate message for MsgB ACK, in accordance with certain aspects of the present disclosure. In case of P2 or P2/P3 beam refinement that involves the BS beam refinement, the beam refinement may be triggered by MsgB followed by the beam report. MsgB ACK may be transmitted using a separate message 1402 based on which the BS decides whether to transmit the scheduled CSI-RS or not. The scheduled CSI-RS is transmitted only when MsgB ACK is received. Thus, the BS may not waste energy on transmitting a CSI-RS that the UE is unaware of, although at the expense of a separate MsgB ACK transmission.

In some cases, the BS may indicate, via MsgB, the gap between the beam refinement command, CSI-RS, and beam report in the presence of a separate MsgB ACK transmission. In some case, the BS may indicate, via MsgB, the timing (e.g., in terms of a number of slots) of the CSI-RS and beam report using MsgB as the reference. For example, MsgB may indicate the gap between MsgB and CSI-RS transmission and the gap between MsgB and the beam report. In some cases, the BS may indicate, via MsgB, the timing (e.g., in terms of a number of slots) of the CSI-RS and beam report using MsgB ACK as the reference. For example, MsgB may indicate the gap between the MsgB ACK (e.g., message 1402) and CSI-RS transmission and the gap between MsgB ACK (e.g., message 1402) and the beam report.

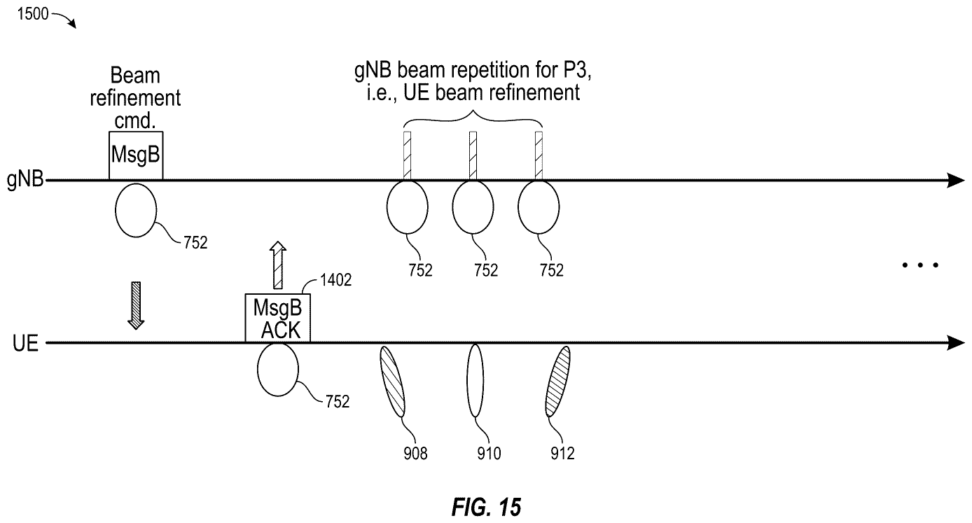

FIG. 15 illustrates example signal communications 1500 with P3 beam refinement and MsgB ACK, in accordance with certain aspects of the present disclosure. In case of P3 beam refinement where a beam report message is not used, the MsgB ACK may be transmitted separately as part of message 1402 based on which the BS decides whether to transmit the scheduled CSI-RS or not. The scheduled CSI-RS may be transmitted only when MsgB ACK is received. In this case, MsgB may indicate the timing of the CSI-RS using MsgB as the reference or MsgB may indicate the timing of the CSI-RS using MsgB ACK as the reference.

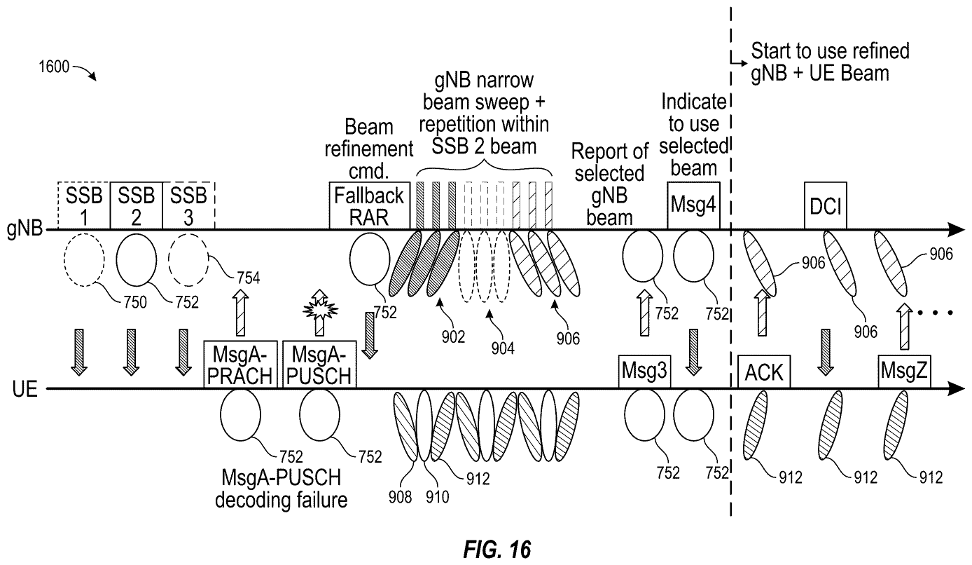

FIG. 16 illustrates example signal communications 1600 with a fallback RAR used to trigger BS and/or UE beam refinement, in accordance with certain aspects of the present disclosure. MsgA may include a physical random access channel (PRACH) (labeled “MsgA-PRACH”) and a PUSCH (labeled “MsgA-PUSCH”). In some cases, the UE may transmit MsgA-PRACH which may be received by a BS, followed by Msg-PUSCH which may not be received by the BS, resulting in a failure of the two-step RACH procedure. The UE and BS may fall back to the four-step RACH procedure with the BS transmitting a fallback RAR using the beam 752. In case of MsgA-PUSCH decoding failure, the fallback RAR triggers the BS and/or UE beam refinement by scheduling the CSI-RS and the BS and/or UE beam refinement may be carried out based on the scheduled CSI-RS. For instance, CSI-RS transmissions (e.g., for P2/P3 beam refinement) may be performed after the fallback RAR is transmitted. After the CSI-RS transmissions, Msg3 of the four-step RACH procedure may be transmitted using the wide beam 752, reporting the one or more selected narrow beams. The BS may then transmit Msg4 of the four-step RACH procedure to indicate the beam to be used. After Msg4, the refined BS and UE beams may be used for transmission of an ACK of Msg4 (e.g., corresponding to operations 530 of FIG. 5A), transmission of DCI, and transmission of MsgZ scheduled by the DCI.

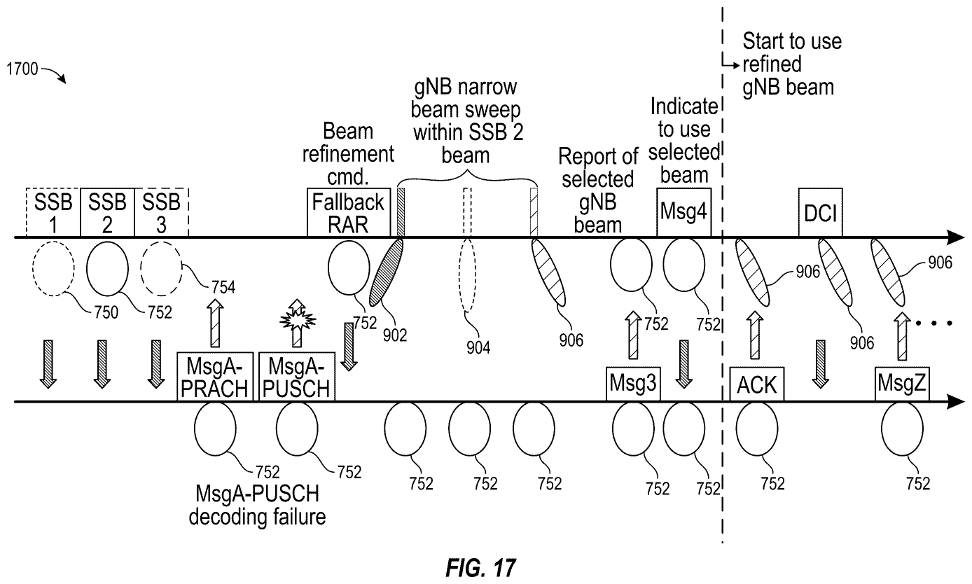

FIG. 17 illustrates example signal communications 1700 with a fallback RAR used to trigger BS (P2) beam refinement, in accordance with certain aspects of the present disclosure. As shown, fallback RAR may trigger the BS beam refinement. After the CSI-RS transmissions for the BS beam refinement, Msg3 may report the one or more beams, and Msg4 may indicate a beam to be used. The ACK may be transmitted using the beam 752 and received by the BS using the selected narrow beam 906. The BS may transmit the DCI using beam 906 and the UE may receive the DCI using beam 752. The DCI may schedule transmission of MsgZ that may be transmitted by the UE using beam 752 and received by the BS using the beam 906. In case of P2 or P2/P3 beam refinement that involves the BS beam refinement, the refined beam pair is used after the beam report is transmitted in Msg3 and the gNB indication of the best beam pair in Msg4, as shown.

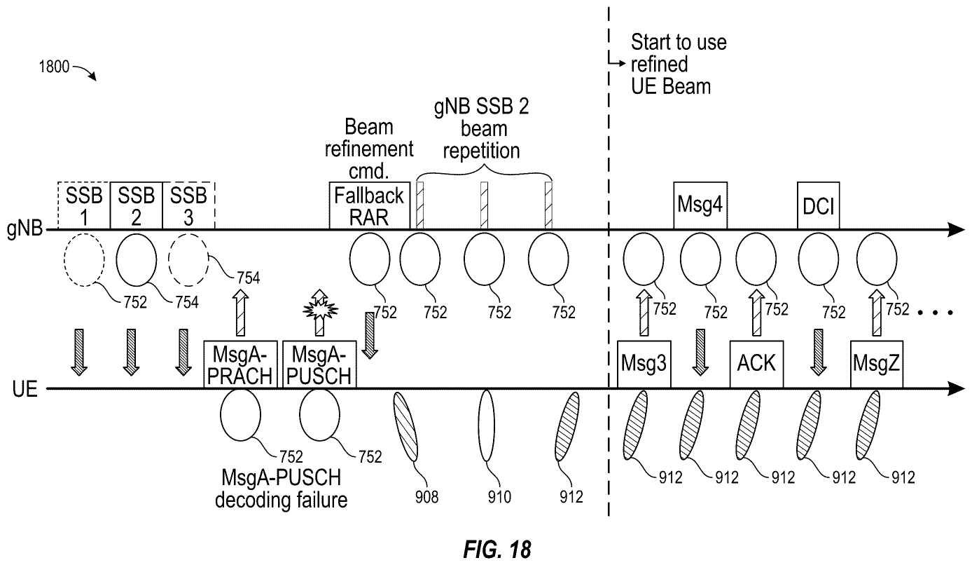

FIG. 18 illustrates example signal communications 1800 with a fallback RAR used to trigger UE (P3) beam refinement, in accordance with certain aspects of the present disclosure. As shown, after the fallback RAR is transmitted using beam 752, CSI-RS transmission are performed for the UE beam refinement. The UE then transmits Msg3 of the four-step RACH procedure using a selected narrow beam 912 that may be received by the BS using beam 752. The BS may transmit Msg4 using beam 752 that may be received using beam 912. The UE may then transmit an ACK of Msg4 using beam 912 that may be received using beam 752. The BS then transmits the DCI using beam 752 that is received by the UE using beam 912 and the UE transmit MsgZ scheduled by the DCI using the beam 912. In case of P3 beam refinement, neither the beam report nor the BS indication of the best beam pair may be used. As shown, the refined beam pair (e.g., beam 752 and beam 912) may be used starting from Msg3. The BS and the UE use the initial beam (e.g., beam 752) of the best SSB until the best beam pair is determined/indicated.

### Example Operations

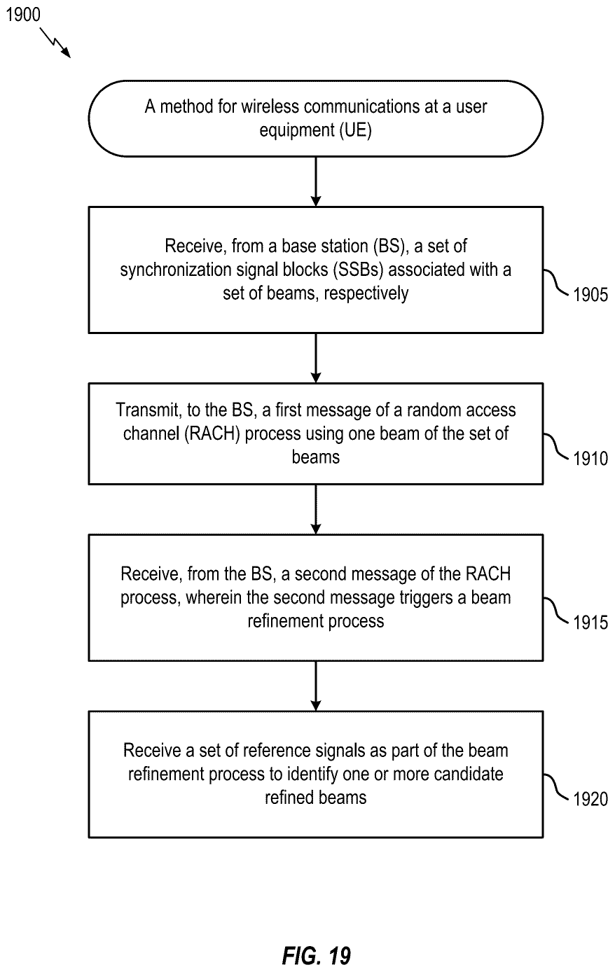

FIG. 19 shows an example of a method 1900 of wireless communications at a user equipment (UE), such as a UE 104 of FIGS. 1 and 3.

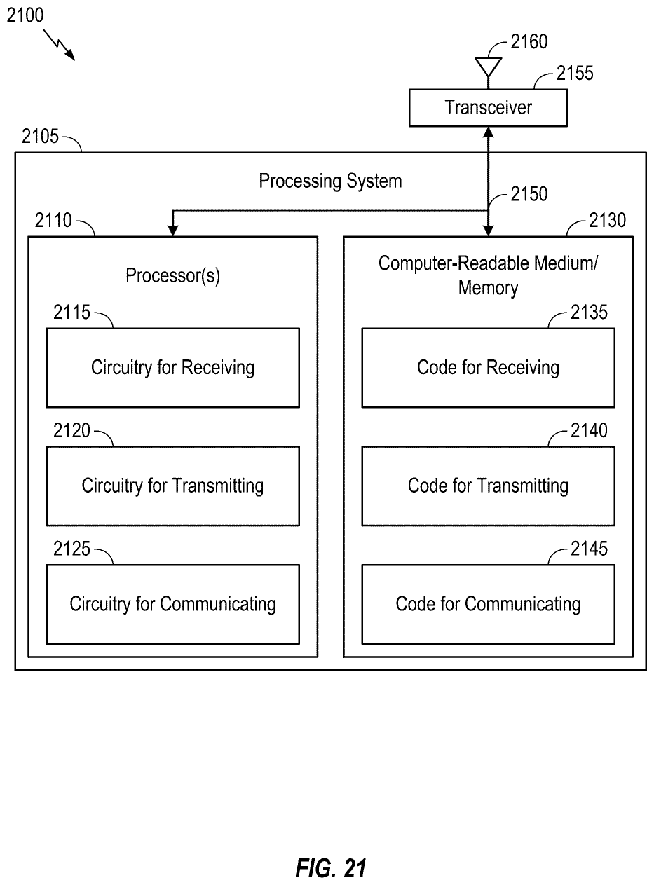

Method 1900 begins at step 1905 with receiving, from a base station (BS), a set of synchronization signal blocks (SSBs) associated with a set of beams, respectively. In some cases, the operations of this step refer to, or may be performed by, circuitry for receiving and/or code for receiving as described with reference to FIG. 21.

Method 1900 then proceeds to step 1910 with transmitting, to the BS, a first message of a random access channel (RACH) process using one beam of the set of beams. In some cases, the operations of this step refer to, or may be performed by, circuitry for transmitting and/or code for transmitting as described with reference to FIG. 21.

Method 1900 then proceeds to step 1915 with receiving, from the BS, a second message of the RACH process, wherein the second message triggers a beam refinement process. In some cases, the operations of this step refer to, or may be performed by, circuitry for receiving and/or code for receiving as described with reference to FIG. 21.

Method 1900 then proceeds to step 1920 with receiving a set of reference signals as part of the beam refinement process to identify one or more candidate refined beams. In some cases, the operations of this step refer to, or may be performed by, circuitry for receiving and/or code for receiving as described with reference to FIG. 21.

In some aspects, the set of beams include wide beams, and wherein the one or more candidate refined beams include one or more narrow beams within the one beam of the set of beams.

In some aspects, the second message triggers one of a set of beam refinement processes including the beam refinement process, the set of beam refinement processes including: a UE beam refinement process to refine a beam used by the UE for transmission or reception; a BS beam refinement process to refine a beam used by the BS for transmission or reception; and a BS and UE beam refinement process to refine the beams used by the UE and the BS for transmission or reception.

In some aspects, the method 1900 further includes transmitting a third message including a beam report indicating the one or more candidate refined beams. In some cases, the operations of this step refer to, or may be performed by, circuitry for transmitting and/or code for transmitting as described with reference to FIG. 21.

In some aspects, the method 1900 further includes receiving a fourth message indicating a selected beam of the one or more candidate refined beams. In some cases, the operations of this step refer to, or may be performed by, circuitry for receiving and/or code for receiving as described with reference to FIG. 21.

In some aspects, the method 1900 further includes communicating with the BS using the selected beam after receiving the fourth message. In some cases, the operations of this step refer to, or may be performed by, circuitry for communicating and/or code for communicating as described with reference to FIG. 21.

In some aspects, the first message indicates one or more capabilities of the UE, and wherein the beam refinement process is in accordance with the one or more capabilities of the UE.

In some aspects, the one or more capabilities include at least one of: a UE beam configuration indicating a number of beams supported by the UE; a type of beam refinement supported by the UE; reference signal (RS) measurement and reporting configuration of the UE indicating at least one of a number of beams that the UE can measure during the beam refinement process or a number of beams the UE can report as part of a beam reporting message; and a minimum gap between a beam sweep for the beam refinement process and transmission of the beam reporting message; or a minimum gap between receiving the second message and the beam sweep for the beam refinement process.

In some aspects, the method 1900 further includes transmitting a third message including a beam report indicating the one or more candidate refined beams, wherein an acknowledgement that the second message is successfully decoded by the UE is multiplexed as part of the third message. In some cases, the operations of this step refer to, or may be performed by, circuitry for transmitting and/or code for transmitting as described with reference to FIG. 21.

In some aspects, the method 1900 further includes transmitting a third message including a beam report indicating the one or more candidate refined beams, the third message serving as an acknowledgement that the second message is successfully decoded by the UE. In some cases, the operations of this step refer to, or may be performed by, circuitry for transmitting and/or code for transmitting as described with reference to FIG. 21.

In some aspects, the method 1900 further includes transmitting a third message prior to receiving the set of reference signals, wherein the third message provides an acknowledgement that the second message is successfully decoded by the UE. In some cases, the operations of this step refer to, or may be performed by, circuitry for transmitting and/or code for transmitting as described with reference to FIG. 21.

In some aspects, the second message indicates a timing associated with at least one of receiving the set of reference signals or transmission of a beam report indicating the one or more candidate refined beams, the timing being indicated with reference to the third message.

In some aspects, the second message indicates a timing associated with at least one of receiving the set of reference signals or transmission of a beam report indicating the one or more candidate refined beams, the timing being indicated with reference to the second message.

In some aspects, the second message comprises a fallback random access response (RAR) triggering the beam refinement process.

In some aspects, the RACH process comprises a two-step RACH process, and wherein the fallback RAR indicates to perform a four-step RACH process based on the two-step RACH process failing.

In some aspects, the method 1900 further includes transmitting a third message of the four-step RACH process including a beam report indicating the one or more candidate refined beams. In some cases, the operations of this step refer to, or may be performed by, circuitry for transmitting and/or code for transmitting as described with reference to FIG. 21.

In some aspects, the method 1900 further includes receiving a fourth message of the four-step RACH process indicating a selected beam of the one or more candidate refined beams. In some cases, the operations of this step refer to, or may be performed by, circuitry for receiving and/or code for receiving as described with reference to FIG. 21.

In some aspects, the method 1900 further includes communicating with the BS using the selected beam after receiving the fourth message. In some cases, the operations of this step refer to, or may be performed by, circuitry for communicating and/or code for communicating as described with reference to FIG. 21.

In some aspects, the beam refinement process comprises a UE beam refinement process, the method further comprising: transmitting a third message of the four-step RACH process using a selected beam of the one or more candidate refined beams; and receiving a fourth message of the four-step RACH process using the selected beam.

In one aspect, method 1900, or any aspect related to it, may be performed by an apparatus, such as communications device 2100 of FIG. 21, which includes various components operable, configured, or adapted to perform the method 1900. Communications device 2100 is described below in further detail.

Note that FIG. 19 is just one example of a method, and other methods including fewer, additional, or alternative steps are possible consistent with this disclosure.

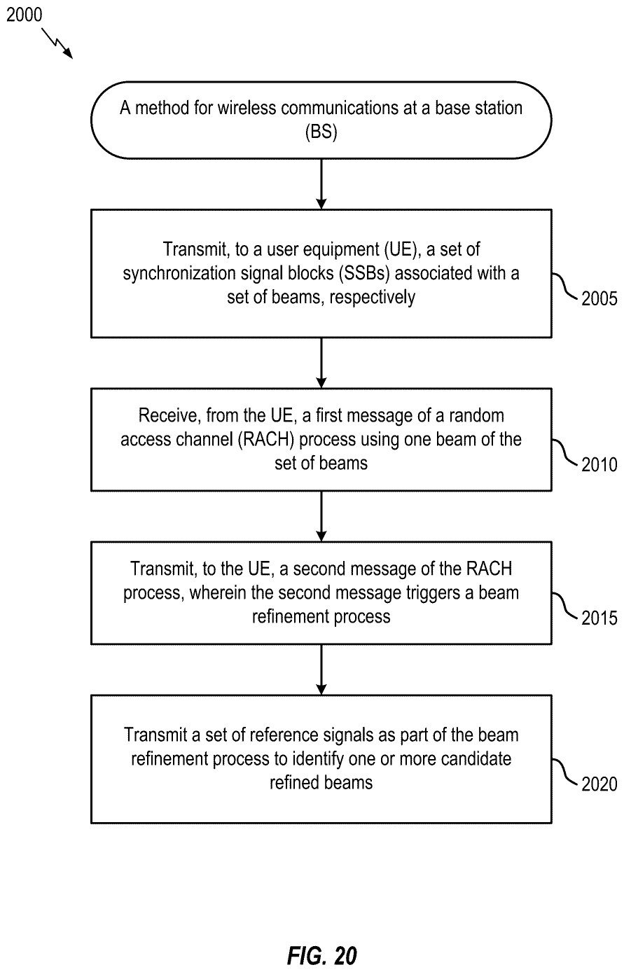

FIG. 20 shows an example of a method 2000 of wireless communications at a base station (BS), such as a BS 102 of FIGS. 1 and 3, or a disaggregated base station as discussed with respect to FIG. 2.

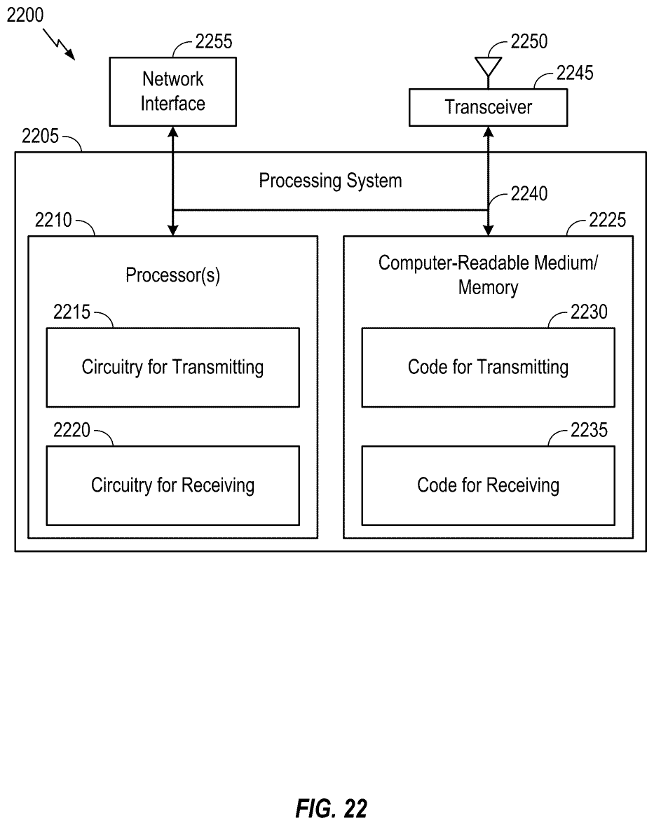

Method 2000 begins at step 2005 with transmitting, to a user equipment (UE), a set of synchronization signal blocks (SSBs) associated with a set of beams, respectively. In some cases, the operations of this step refer to, or may be performed by, circuitry for transmitting and/or code for transmitting as described with reference to FIG. 22.

Method 2000 then proceeds to step 2010 with receiving, from the UE, a first message of a random access channel (RACH) process using one beam of the set of beams. In some cases, the operations of this step refer to, or may be performed by, circuitry for receiving and/or code for receiving as described with reference to FIG. 22.

Method 2000 then proceeds to step 2015 with transmitting, to the UE, a second message of the RACH process, wherein the second message triggers a beam refinement process. In some cases, the operations of this step refer to, or may be performed by, circuitry for transmitting and/or code for transmitting as described with reference to FIG. 22.

Method 2000 then proceeds to step 2020 with transmitting a set of reference signals as part of the beam refinement process to identify one or more candidate refined beams. In some cases, the operations of this step refer to, or may be performed by, circuitry for transmitting and/or code for transmitting as described with reference to FIG. 22.

In some aspects, the set of beams include wide beams, and wherein the one or more candidate refined beams include one or more narrow beams within the one beam of the set of beams.

In some aspects, the second message triggers one of a set of beam refinement processes including the beam refinement process, the set of beam refinement processes including: a UE beam refinement process to refine a beam used by the UE for transmission or reception; a BS beam refinement process to refine a beam used by the BS for transmission or reception; and a BS and UE beam refinement process to refine the beams used by the UE and the BS for transmission or reception.

In some aspects, the method 2000 further includes receiving a third message including a beam report indicating the one or more candidate refined beams. In some cases, the operations of this step refer to, or may be performed by, circuitry for receiving and/or code for receiving as described with reference to FIG. 22.

In some aspects, the method 2000 further includes transmitting a fourth message indicating a selected beam of the one or more candidate refined beams. In some cases, the operations of this step refer to, or may be performed by, circuitry for transmitting and/or code for transmitting as described with reference to FIG. 22.

In some aspects, the first message indicates one or more capabilities of the UE, and wherein the beam refinement process is in accordance with the one or more capabilities of the UE.

In some aspects, the one or more capabilities include at least one of: a UE beam configuration indicating a number of beams supported by the UE; a type of beam refinement supported by the UE; reference signal (RS) measurement and reporting configuration of the UE indicating at least one of a number of beams that the UE can measure during the beam refinement process or a number of beams the UE can report as part of a beam reporting message; and a minimum gap between a beam sweep for the beam refinement process and transmission of the beam reporting message; or a minimum gap between receiving the second message and the beam sweep for the beam refinement process.

In some aspects, the method 2000 further includes receiving a third message including a beam report indicating the one or more candidate refined beams, wherein an acknowledgement that the second message is successfully decoded by the UE is multiplexed as part of the third message. In some cases, the operations of this step refer to, or may be performed by, circuitry for receiving and/or code for receiving as described with reference to FIG. 22.

In some aspects, the method 2000 further includes receiving a third message including a beam report indicating the one or more candidate refined beams, the third message serving as an acknowledgement that the second message is successfully decoded by the UE. In some cases, the operations of this step refer to, or may be performed by, circuitry for receiving and/or code for receiving as described with reference to FIG. 22.

In some aspects, the method 2000 further includes receiving a third message prior to receiving the set of reference signals, wherein the third message provides an acknowledgement that the second message is successfully decoded by the UE. In some cases, the operations of this step refer to, or may be performed by, circuitry for receiving and/or code for receiving as described with reference to FIG. 22.

In some aspects, the second message indicates a timing associated with at least one of transmitting the set of reference signals or transmission of a beam report indicating the one or more candidate refined beams, the timing being indicated with reference to the third message.

In some aspects, the second message indicates a timing associated with at least one of transmitting the set of reference signals or transmission of a beam report indicating the one or more candidate refined beams, the timing being indicated with reference to the second message.

In some aspects, the second message comprises a fallback random access response (RAR) triggering the beam refinement process.

In some aspects, the RACH process comprises a two-step RACH process, and wherein the fallback RAR indicates to perform a four-step RACH process based on the two-step RACH process failing.

In some aspects, the method 2000 further includes receiving a third message of the four-step RACH process including a beam report indicating the one or more candidate refined beams. In some cases, the operations of this step refer to, or may be performed by, circuitry for receiving and/or code for receiving as described with reference to FIG. 22.

In some aspects, the method 2000 further includes transmitting a fourth message of the four-step RACH process indicating a selected beam of the one or more candidate refined beams. In some cases, the operations of this step refer to, or may be performed by, circuitry for transmitting and/or code for transmitting as described with reference to FIG. 22.

In one aspect, method 2000, or any aspect related to it, may be performed by an apparatus, such as communications device 2200 of FIG. 22, which includes various components operable, configured, or adapted to perform the method 2000. Communications device 2200 is described below in further detail.

Note that FIG. 20 is just one example of a method, and other methods including fewer, additional, or alternative steps are possible consistent with this disclosure.

### Example Communications Device(s)

FIG. 21 depicts aspects of an example communications device 2100. In some aspects, communications device 2100 is a user equipment, such as UE 104 described above with respect to FIGS. 1 and 3.

The communications device 2100 includes a processing system 2105 coupled to the transceiver 2155 (e.g., a transmitter and/or a receiver). The transceiver 2155 is configured to transmit and receive signals for the communications device 2100 via the antenna 2160, such as the various signals as described herein. The processing system 2105 may be configured to perform processing functions for the communications device 2100, including processing signals received and/or to be transmitted by the communications device 2100.

The processing system 2105 includes one or more processors 2110. In various aspects, the one or more processors 2110 may be representative of one or more of receive processor 358, transmit processor 364, TX MIMO processor 366, and/or controller/processor 380, as described with respect to FIG. 3. The one or more processors 2110 are coupled to a computer-readable medium/memory 2130 via a bus 2150. In certain aspects, the computer-readable medium/memory 2130 is configured to store instructions (e.g., computer-executable code) that when executed by the one or more processors 2110, cause the one or more processors 2110 to perform the method 1900 described with respect to FIG. 19, or any aspect related to it. Note that reference to a processor performing a function of communications device 2100 may include one or more processors 2110 performing that function of communications device 2100.

In the depicted example, computer-readable medium/memory 2130 stores code (e.g., executable instructions), such as code for receiving 2135, code for transmitting 2140, and code for communicating 2145. Processing of the code for receiving 2135, code for transmitting 2140, and code for communicating 2145 may cause the communications device 2100 to perform the method 1900 described with respect to FIG. 19, or any aspect related to it.

The one or more processors 2110 include circuitry configured to implement (e.g., execute) the code stored in the computer-readable medium/memory 2130, including circuitry such as circuitry for receiving 2115, circuitry for transmitting 2120, and circuitry for communicating 2125. Processing with circuitry for receiving 2115, circuitry for transmitting 2120, and circuitry for communicating 2125 may cause the communications device 2100 to perform the method 1900 described with respect to FIG. 19, or any aspect related to it.

Various components of the communications device 2100 may provide means for performing the method 1900 described with respect to FIG. 19, or any aspect related to it. For example, means for transmitting, sending or outputting for transmission may include transceivers 354 and/or antenna(s) 352 of the UE 104 illustrated in FIG. 3 and/or the transceiver 2155 and the antenna 2160 of the communications device 2100 in FIG. 21. Means for receiving or obtaining may include transceivers 354 and/or antenna(s) 352 of the UE 104 illustrated in FIG. 3 and/or the transceiver 2155 and the antenna 2160 of the communications device 2100 in FIG. 21.

FIG. 22 depicts aspects of an example communications device 2200. In some aspects, communications device 2200 is a network entity, such as BS 102 of FIGS. 1 and 3, or a disaggregated base station as discussed with respect to FIG. 2.

The communications device 2200 includes a processing system 2205 coupled to the transceiver 2245 (e.g., a transmitter and/or a receiver) and/or a network interface 2255. The transceiver 2245 is configured to transmit and receive signals for the communications device 2200 via the antenna 2250, such as the various signals as described herein. The network interface 2255 is configured to obtain and send signals for the communications device 2200 via communication link(s), such as a backhaul link, midhaul link, and/or fronthaul link as described herein, such as with respect to FIG. 2. The processing system 2205 may be configured to perform processing functions for the communications device 2200, including processing signals received and/or to be transmitted by the communications device 2200.

The processing system 2205 includes one or more processors 2210. In various aspects, one or more processors 2210 may be representative of one or more of receive processor 338, transmit processor 320, TX MIMO processor 330, and/or controller/processor 340, as described with respect to FIG. 3. The one or more processors 2210 are coupled to a computer-readable medium/memory 2225 via a bus 2240. In certain aspects, the computer-readable medium/memory 2225 is configured to store instructions (e.g., computer-executable code) that when executed by the one or more processors 2210, cause the one or more processors 2210 to perform the method 2000 described with respect to FIG. 20, or any aspect related to it. Note that reference to a processor of communications device 2200 performing a function may include one or more processors 2210 of communications device 2200 performing that function.

In the depicted example, the computer-readable medium/memory 2225 stores code (e.g., executable instructions), such as code for transmitting 2230 and code for receiving 2235. Processing of the code for transmitting 2230 and code for receiving 2235 may cause the communications device 2200 to perform the method 2000 described with respect to FIG. 20, or any aspect related to it.

The one or more processors 2210 include circuitry configured to implement (e.g., execute) the code stored in the computer-readable medium/memory 2225, including circuitry such as circuitry for transmitting 2215 and circuitry for receiving 2220. Processing with circuitry for transmitting 2215 and circuitry for receiving 2220 may cause the communications device 2200 to perform the method 2000 described with respect to FIG. 20, or any aspect related to it.

Various components of the communications device 2200 may provide means for performing the method 2000 described with respect to FIG. 20, or any aspect related to it. Means for transmitting, sending or outputting for transmission may include transceivers 332 and/or antenna(s) 334 of the BS 102 illustrated in FIG. 3 and/or the transceiver 2245 and the antenna 2250 of the communications device 2200 in FIG. 22. Means for receiving or obtaining may include transceivers 332 and/or antenna(s) 334 of the BS 102 illustrated in FIG. 3 and/or the transceiver 2245 and the antenna 2250 of the communications device 2200 in FIG. 22.

### Example Clauses

Implementation examples are described in the following numbered clauses:
Clause 1: A method for wireless communications at a user equipment (UE), comprising: receiving, from a base station (BS), a set of synchronization signal blocks (SSBs) associated with a set of beams, respectively; transmitting, to the BS, a first message of a random access channel (RACH) process using one beam of the set of beams; receiving, from the BS, a second message of the RACH process, wherein the second message triggers a beam refinement process; and receiving a set of reference signals as part of the beam refinement process to identify one or more candidate refined beams.
Clause 2: The method of Clause 1, wherein the set of beams include wide beams, and wherein the one or more candidate refined beams include one or more narrow beams within the one beam of the set of beams.
Clause 3: The method of any one of Clauses 1-2, wherein the second message triggers one of a set of beam refinement processes including the beam refinement process, the set of beam refinement processes including: a UE beam refinement process to refine a beam used by the UE for transmission or reception; a BS beam refinement process to refine a beam used by the BS for transmission or reception; and a BS and UE beam refinement process to refine the beams used by the UE and the BS for transmission or reception.
Clause 4: The method of any one of Clauses 1-3, further comprising: transmitting a third message including a beam report indicating the one or more candidate refined beams; receiving a fourth message indicating a selected beam of the one or more candidate refined beams; and communicating with the BS using the selected beam after receiving the fourth message.
Clause 5: The method of any one of Clauses 1-4, wherein the first message indicates one or more capabilities of the UE, and wherein the beam refinement process is in accordance with the one or more capabilities of the UE.
Clause 6: The method of Clause 5, wherein the one or more capabilities include at least one of: a UE beam configuration indicating a number of beams supported by the UE; a type of beam refinement supported by the UE; reference signal (RS) measurement and reporting configuration of the UE indicating at least one of a number of beams that the UE can measure during the beam refinement process or a number of beams the UE can report as part of a beam reporting message; and a minimum gap between a beam sweep for the beam refinement process and transmission of the beam reporting message; or a minimum gap between receiving the second message and the beam sweep for the beam refinement process.
Clause 7: The method of any one of Clauses 1-6, further comprising transmitting a third message including a beam report indicating the one or more candidate refined beams, wherein an acknowledgement that the second message is successfully decoded by the UE is multiplexed as part of the third message.
Clause 8: The method of any one of Clauses 1-7, further comprising transmitting a third message including a beam report indicating the one or more candidate refined beams, the third message serving as an acknowledgement that the second message is successfully decoded by the UE.
Clause 9: The method of any one of Clauses 1-8, further comprising transmitting a third message prior to receiving the set of reference signals, wherein the third message provides an acknowledgement that the second message is successfully decoded by the UE.
Clause 10: The method of Clause 9, wherein the second message indicates a timing associated with at least one of receiving the set of reference signals or transmission of a beam report indicating the one or more candidate refined beams, the timing being indicated with reference to the third message.
Clause 11: The method of any one of Clauses 1-10, wherein the second message indicates a timing associated with at least one of receiving the set of reference signals or transmission of a beam report indicating the one or more candidate refined beams, the timing being indicated with reference to the second message.
Clause 12: The method any one of Clauses 1-11, wherein the second message comprises a fallback random access response (RAR) triggering the beam refinement process.
Clause 13: The method of Clause 12, wherein the RACH process comprises a two-step RACH process, and wherein the fallback RAR indicates to perform a four-step RACH process based on the two-step RACH process failing.
Clause 14: The method of Clause 13, further comprising: transmitting a third message of the four-step RACH process including a beam report indicating the one or more candidate refined beams; receiving a fourth message of the four-step RACH process indicating a selected beam of the one or more candidate refined beams; and communicating with the BS using the selected beam after receiving the fourth message.
Clause 15: The method of Clause 13, wherein the beam refinement process comprises a UE beam refinement process, the method further comprising: transmitting a third message of the four-step RACH process using a selected beam of the one or more candidate refined beams; and receiving a fourth message of the four-step RACH process using the selected beam.
Clause 16: A method for wireless communications at a base station (BS), comprising: transmitting, to a user equipment (UE), a set of synchronization signal blocks (SSBs) associated with a set of beams, respectively; receiving, from the UE, a first message of a random access channel (RACH) process using one beam of the set of beams; transmitting, to the UE, a second message of the RACH process, wherein the second message triggers a beam refinement process; and transmitting a set of reference signals as part of the beam refinement process to identify one or more candidate refined beams.
Clause 17: The method of Clause 16, wherein the set of beams include wide beams, and wherein the one or more candidate refined beams include one or more narrow beams within the one beam of the set of beams.
Clause 18: The method of any one of Clauses 16-17, wherein the second message triggers one of a set of beam refinement processes including the beam refinement process, the set of beam refinement processes including: a UE beam refinement process to refine a beam used by the UE for transmission or reception; a BS beam refinement process to refine a beam used by the BS for transmission or reception; and a BS and UE beam refinement process to refine the beams used by the UE and the BS for transmission or reception.
Clause 19: The method of any one of Clauses 16-18, further comprising: receiving a third message including a beam report indicating the one or more candidate refined beams; and transmitting a fourth message indicating a selected beam of the one or more candidate refined beams.
Clause 20: The method of any one of Clauses 16-19, wherein the first message indicates one or more capabilities of the UE, and wherein the beam refinement process is in accordance with the one or more capabilities of the UE.
Clause 21: The method of Clause 20, wherein the one or more capabilities include at least one of: a UE beam configuration indicating a number of beams supported by the UE; a type of beam refinement supported by the UE; reference signal (RS) measurement and reporting configuration of the UE indicating at least one of a number of beams that the UE can measure during the beam refinement process or a number of beams the UE can report as part of a beam reporting message; and a minimum gap between a beam sweep for the beam refinement process and transmission of the beam reporting message; or a minimum gap between receiving the second message and the beam sweep for the beam refinement process.
Clause 22: The method of any one of Clauses 16-21, further comprising receiving a third message including a beam report indicating the one or more candidate refined beams, wherein an acknowledgement that the second message is successfully decoded by the UE is multiplexed as part of the third message.
Clause 23: The method of any one of Clauses 16-22, further comprising receiving a third message including a beam report indicating the one or more candidate refined beams, the third message serving as an acknowledgement that the second message is successfully decoded by the UE.
Clause 24: The method of any one of Clauses 16-23, further comprising receiving a third message prior to receiving the set of reference signals, wherein the third message provides an acknowledgement that the second message is successfully decoded by the UE.
Clause 25: The method of Clause 24, wherein the second message indicates a timing associated with at least one of transmitting the set of reference signals or transmission of a beam report indicating the one or more candidate refined beams, the timing being indicated with reference to the third message.
Clause 26: The method of any one of Clauses 16-25, wherein the second message indicates a timing associated with at least one of transmitting the set of reference signals or transmission of a beam report indicating the one or more candidate refined beams, the timing being indicated with reference to the second message.
Clause 27: The method any one of Clauses 16-26, wherein the second message comprises a fallback random access response (RAR) triggering the beam refinement process.
Clause 28: The method of Clause 27, wherein the RACH process comprises a two-step RACH process, and wherein the fallback RAR indicates to perform a four-step RACH process based on the two-step RACH process failing.
Clause 29: The method of Clause 28, further comprising: receiving a third message of the four-step RACH process including a beam report indicating the one or more candidate refined beams; and transmitting a fourth message of the four-step RACH process indicating a selected beam of the one or more candidate refined beams.
Clause 30: An apparatus, comprising: at least one memory comprising executable instructions; and at least one processor configured to execute the executable instructions and cause the apparatus to perform a method in accordance with any combination of Clauses 1-29.
Clause 31: An apparatus, comprising means for performing a method in accordance with any combination of Clauses 1-29.
Clause 32: A non-transitory computer-readable medium comprising executable instructions that, when executed by at least one processor of an apparatus, cause the apparatus to perform a method in accordance with any combination of Clauses 1-29.
Clause 33: A computer program product embodied on a computer-readable storage medium comprising code for performing a method in accordance with any combination of Clauses 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a graphics processing unit (GPU), a neural processing unit (NPU), a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

Means for receiving, means for transmitting, and means for communicating may comprise one or more processors, such as one or more of the processors described above with reference to FIG. 21, and FIG. 22.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising:
at least one memory comprising computer-executable instructions; and
one or more processors configured to execute the computer-executable instructions and cause the apparatus to:
receive, from a base station (BS), a set of synchronization signal blocks (SSBs) associated with a set of beams, respectively;
transmit, to the BS, a first message of a random access channel (RACH) process using one beam of the set of beams;
receive, from the BS, a second message of the RACH process, wherein the second message triggers a beam refinement process; and
receive a set of reference signals as part of the beam refinement process to identify one or more candidate refined beams.

2. The apparatus of claim 1, wherein the set of beams include wide beams, and wherein the one or more candidate refined beams include one or more narrow beams within the one beam of the set of beams.

3. The apparatus of claim 1, wherein the second message triggers one of a set of beam refinement processes including the beam refinement process, the set of beam refinement processes including:
a UE beam refinement process to refine a beam used by the UE for transmission or reception;
a BS beam refinement process to refine a beam used by the BS for transmission or reception; and
a BS and UE beam refinement process to refine the beams used by the UE and the BS for transmission or reception.

4. The apparatus of claim 1, wherein the one or more processors are further configured to cause the apparatus to:
transmit a third message including a beam report indicating the one or more candidate refined beams;
receive a fourth message indicating a selected beam of the one or more candidate refined beams; and
communicate with the BS using the selected beam after receiving the fourth message.

5. The apparatus of claim 1, wherein the first message indicates one or more capabilities of the UE, and wherein the beam refinement process is in accordance with the one or more capabilities of the UE.

6. The apparatus of claim 5, wherein the one or more capabilities include at least one of:
a UE beam configuration indicating a number of beams supported by the UE;
a type of beam refinement supported by the UE;
reference signal (RS) measurement and reporting configuration of the UE indicating at least one of a number of beams that the UE can measure during the beam refinement process or a number of beams the UE can report as part of a beam reporting message; and
a minimum gap between a beam sweep for the beam refinement process and transmission of the beam reporting message; or a minimum gap between receiving the second message and the beam sweep for the beam refinement process.

7. The apparatus of claim 1, wherein the one or more processors are further configured to cause the apparatus to:
transmit a third message including a beam report indicating the one or more candidate refined beams, wherein an acknowledgement that the second message is successfully decoded by the UE is multiplexed as part of the third message.

8. The apparatus of claim 1, wherein the one or more processors are further configured to cause the apparatus to:
transmit a third message including a beam report indicating the one or more candidate refined beams, the third message serving as an acknowledgement that the second message is successfully decoded by the UE.

9. The apparatus of claim 1, wherein the one or more processors are further configured to cause the apparatus to:
transmit a third message prior to receiving the set of reference signals, wherein the third message provides an acknowledgement that the second message is successfully decoded by the UE.

10. The apparatus of claim 9, wherein the second message indicates a timing associated with at least one of receiving the set of reference signals or transmission of a beam report indicating the one or more candidate refined beams, the timing being indicated with reference to the third message.

11. The apparatus of claim 1, wherein the second message indicates a timing associated with at least one of receiving the set of reference signals or transmission of a beam report indicating the one or more candidate refined beams, the timing being indicated with reference to the second message.

12. The apparatus of claim 1, wherein the second message comprises a fallback random access response (RAR) triggering the beam refinement process.

13. The apparatus of claim 12, wherein the RACH process comprises a two-step RACH process, and wherein the fallback RAR indicates to perform a four-step RACH process based on the two-step RACH process failing.

14. The apparatus of claim 13, wherein the one or more processors are further configured to cause the apparatus to:
transmit a third message of the four-step RACH process including a beam report indicating the one or more candidate refined beams;
receive a fourth message of the four-step RACH process indicating a selected beam of the one or more candidate refined beams; and
communicate with the BS using the selected beam after receiving the fourth message.

15. The apparatus of claim 13, wherein the beam refinement process comprises a UE beam refinement process, the method further comprising:
transmitting a third message of the four-step RACH process using a selected beam of the one or more candidate refined beams; and
receiving a fourth message of the four-step RACH process using the selected beam.

16. An apparatus for wireless communication, comprising:
at least one memory comprising computer-executable instructions; and
one or more processors configured to execute the computer-executable instructions and cause the apparatus to:
transmit, to a user equipment (UE), a set of synchronization signal blocks (SSBs) associated with a set of beams, respectively;
receive, from the UE, a first message of a random access channel (RACH) process using one beam of the set of beams;
transmit, to the UE, a second message of the RACH process, wherein the second message triggers a beam refinement process; and
transmit a set of reference signals as part of the beam refinement process to identify one or more candidate refined beams.

17. The apparatus of claim 16, wherein the second message triggers one of a set of beam refinement processes including the beam refinement process, the set of beam refinement processes including:
a UE beam refinement process to refine a beam used by the UE for transmission or reception;
a BS beam refinement process to refine a beam used by the BS for transmission or reception; and
a BS and UE beam refinement process to refine the beams used by the UE and the BS for transmission or reception.

18. The apparatus of claim 16, wherein the one or more processors are further configured to cause the apparatus to:
receive a third message including a beam report indicating the one or more candidate refined beams; and
transmit a fourth message indicating a selected beam of the one or more candidate refined beams.

19. The apparatus of claim 16, wherein the first message indicates one or more capabilities of the UE, and wherein the beam refinement process is in accordance with the one or more capabilities of the UE.

20. The apparatus of claim 19, wherein the one or more capabilities include at least one of:
a UE beam configuration indicating a number of beams supported by the UE;
a type of beam refinement supported by the UE; reference signal (RS) measurement and reporting configuration of the UE indicating at least one of a number of beams that the UE can measure during the beam refinement process or a number of beams the UE can report as part of a beam reporting message; and
a minimum gap between a beam sweep for the beam refinement process and transmission of the beam reporting message; or a minimum gap between receiving the second message and the beam sweep for the beam refinement process.

21. The apparatus of claim 16, wherein the one or more processors are further configured to cause the apparatus to:
receive a third message including a beam report indicating the one or more candidate refined beams, wherein an acknowledgement that the second message is successfully decoded by the UE is multiplexed as part of the third message.

22. The apparatus of claim 16, wherein the one or more processors are further configured to cause the apparatus to:
receive a third message including a beam report indicating the one or more candidate refined beams, the third message serving as an acknowledgement that the second message is successfully decoded by the UE.

23. The apparatus of claim 16, wherein the one or more processors are further configured to cause the apparatus to:
receive a third message prior to receiving the set of reference signals, wherein the third message provides an acknowledgement that the second message is successfully decoded by the UE.

24. The apparatus of claim 23, wherein the second message indicates a timing associated with at least one of transmitting the set of reference signals or transmission of a beam report indicating the one or more candidate refined beams, the timing being indicated with reference to the third message.

25. The apparatus of claim 16, wherein the second message indicates a timing associated with at least one of transmitting the set of reference signals or transmission of a beam report indicating the one or more candidate refined beams, the timing being indicated with reference to the second message.

26. The apparatus of claim 16, wherein the second message comprises a fallback random access response (RAR) triggering the beam refinement process.

27. The apparatus of claim 26, wherein the RACH process comprises a two-step RACH process, and wherein the fallback RAR indicates to perform a four-step RACH process based on the two-step RACH process failing.

28. The apparatus of claim 27, wherein the one or more processors are further configured to cause the apparatus to:
receive a third message of the four-step RACH process including a beam report indicating the one or more candidate refined beams; and
transmit a fourth message of the four-step RACH process indicating a selected beam of the one or more candidate refined beams.

29. A method for wireless communications at a user equipment (UE), comprising:
receiving, from a base station (BS), a set of synchronization signal blocks (SSBs) associated with a set of beams, respectively;
transmitting, to the BS, a first message of a random access channel (RACH) process using one beam of the set of beams;
receiving, from the BS, a second message of the RACH process, wherein the second message triggers a beam refinement process; and
receiving a set of reference signals as part of the beam refinement process to identify one or more candidate refined beams.

30. A method for wireless communications at a base station (BS), comprising:
transmitting, to a user equipment (UE), a set of synchronization signal blocks (SSBs) associated with a set of beams, respectively;
receiving, from the UE, a first message of a random access channel (RACH) process using one beam of the set of beams;
transmitting, to the UE, a second message of the RACH process, wherein the second message triggers a beam refinement process; and
transmitting a set of reference signals as part of the beam refinement process to identify one or more candidate refined beams.
